(19) United States
(12) Patent Application Publication
(10) Pub. No.: US 2025/0123882 A1
(43) Pub. Date: Apr. 17, 2025

(54) INFORMATION PROCESSING DEVICE, INFORMATION PROCESSING METHOD, AND RECORDING MEDIUM

(71) Applicant: Preferred Networks, Inc., Tokyo (JP)

(72) Inventor: Ryohto SAWADA, Tokyo (JP)

(21) Appl. No.: 18/910,535

(22) Filed: Oct. 9, 2024

Related U.S. Application Data
(60) Provisional application No. 63/589,740, filed on Oct. 12, 2023.

(30) Foreign Application Priority Data
Jan. 29, 2024 (JP) 2024-010738

(51) Int. Cl. G06F 9/48

(52) U.S. Cl. CPC G06F 9/4843

(57) ABSTRACT

An information processing device includes at least one memory and at least one processor. The at least one processor is configured to generate input information for generating a program to be executed by an experiment device; and acquire the program generated by inputting the input information into a generative model. The input information includes reference information related to the experiment device, and instruction information. The reference information includes definition information related to an interface for executing a function of the experiment device and a sample program using the interface. The instruction information includes information instructing the generative model to generate the program.

### CROSS-REFERENCE TO RELATED APPLICATIONS

This patent application claims priority to U.S. Provisional Application No. 63/589,740, filed on Oct. 12, 2023, and is based on and claims priority to Japanese Patent Application No. 2024-010738 filed on Jan. 29, 2024, the entire contents of which are incorporated herein by reference.

### TECHNICAL FIELD

The present disclosure relates to an information processing device, an information processing method, and a recording medium.

### BACKGROUND

Generative models, such as a large language model (LLM), are known. The generative model is a machine learning model configured to perform a predetermined task in accordance with input information called a prompt and output data generated as a result.

In order to obtain a good output result from the generative model, a technique for optimizing a prompt has been proposed. In the prompt optimization techniques, information that is not included in training data of the generative model is added to a prompt. This type of technique is also referred to as prompt tuning or the like.

### RELATED ART DOCUMENT

### Patent Document

[Patent Document 1] Tanmay Gupta, Aniruddha Kembhavi, “Visual Programming: Compositional visual reasoning without training”, [online], [Search on Nov. 20, 2023]

### SUMMARY

An information processing device according to one aspect of the present disclosure includes at least one memory and at least one processor. The at least one processor is configured to generate input information for generating a program to be executed by an experiment device; and acquire the program generated by inputting the input information into a generative model. The input information includes reference information related to the experiment device, and instruction information. The reference information includes definition information related to an interface for executing a function of the experiment device and a sample program using the interface. The instruction information includes information instructing the generative model to generate the program.

### BRIEF DESCRIPTION OF THE DRAWINGS

FIG. 1 is a block diagram illustrating an example of an overall configuration of an experiment support system;

FIG. 2 is a block diagram illustrating an example of a functional configuration of the experiment support device;

FIG. 3 is a diagram illustrating an example of an experimental condition;

FIG. 4 is a diagram illustrating an example of input information for generating a program;

FIG. 5 is a diagram illustrating an example of an output result including the program;

FIG. 6 is a diagram illustrating an example of input information for generating definition information;

FIG. 7 is a diagram illustrating an example of an output result including the definition information;

FIG. 8 is a flowchart illustrating an example of an experiment support method; and

FIG. 9 is a block diagram illustrating an example of a hardware configuration of a computer.

### DETAILED DESCRIPTION

In the following, embodiments of the present disclosure will be described with reference to the accompanying drawings. Here, in the present specification and drawings, components having substantially the same functional configurations are denoted by the same reference symbols, and duplicated description thereof will be omitted.

### Embodiment

One embodiment of the present disclosure is an experiment support system configured to support an experiment using an experiment device. The experiment support system according to the present embodiment has a function of generating, based on a generative model, a program to be executed by the experiment device. The generative model may be, for example, a large scale language model. The program may be, for example, an interpreter-type program or a compile-type program. Hereinafter, when simply referred to as a “program”, the program includes a source code and a binary code.

In the present embodiment, for example, the experiment support system configured to support an experiment performed for material development will be described. The material development may include a process of acquiring a predetermined physical quantity (also referred to as a physical property value) related to a predetermined material by using an experiment device. Examples of such an experiment device include a prediction device configured to predict a predetermined physical quantity based on a learned model, a simulation device configured to calculate a predetermined physical quantity by molecular simulation, a measurement device configured to measure a predetermined physical quantity by using a sample including the material, and the like.

In order to efficiently advance the material development, it is preferable that an experimenter is proficient in using the experiment device. However, various experiment devices are used in the material development, and the ways how to use the experiment devices are different from each other. Therefore, it takes a long time to learn how to use the experiment devices. A provider of the experiment device may prepare an easy-to-understand graphical user interface (GUI) or the like so that the user of the experiment device can easily understand how to use the experiment device. However, the number and types of inputs vary from experiment device to experiment device, and thus the burden on the development and maintenance of the GUI and the like is large.

Amidst this, a technique of generating a program, a source code, or the like based on a generative model, such as a large-scale language model, is known. Additionally, some generative models include an interactive user interface. The generative model including the interactive user interface repeatedly performs receiving a prompt described in a natural language sentence as input information and outputting an output result generated based on the prompt. In the interactive user interface, the received input information and the output result are displayed in a time series in a single display area in the order of the reception and in the order of the output.

By using an interactive user interface, an input to the experiment device can be received by a unified interface. That is, the experimenter may describe an experimental condition in a natural language sentence without being aware of the difference in the input to each experiment device. The unification of the interfaces of the experiment devices provides a great merit for both the provider and the user of the experiment devices.

Additionally, when the interactive user interface is used, an instruction can be made to modify the program generated by the generative model. If the instruction can be made to modify the program, the user does not need to input the information that has been input once again, and the user can efficiently generate the desired program.

Various programs can be generated by using the generative model. On the other hand, there is a problem in that the generative model cannot handle information that is not present in teaching data. When information related to the experiment device is not present in the teaching data, it is difficult to cause the generative model to generate the program to be executed by the experiment device. Although there is a technique of performing additional learning so that the generative model can handle new information by fine tuning or the like, a sufficient amount of teaching data is required for fine tuning, which is costly.

A method of causing a generative model to learn information that is not included in teaching data from the outside via a prompt without directly training the generative model has been proposed. This type of technique is also referred to as prompt tuning or the like. According to the prompt tuning, it is not necessary to prepare a large amount of teaching data, and new information can be added to the generative model at low cost.

In the present embodiment, reference information related to the experiment device is added to the input information to be input into the generative model. This enables the generative model to generate the program to be executed by the experiment device. In one aspect, according to the present embodiment, the program to be executed by the experiment device can be generated. In another aspect, according to the present embodiment, experiments for material development can be efficiently performed.

Here, the present embodiment is not limited to experiments performed for the material development, and can be applied to experiments performed in various technical fields. Additionally, in the present embodiment, the experiments includes simulations. The simulations include simulations performed in various technical fields, such as chemoinformatics, materials informatics, and bioinformatics.

### <Overall Configuration of Experiment Support System>

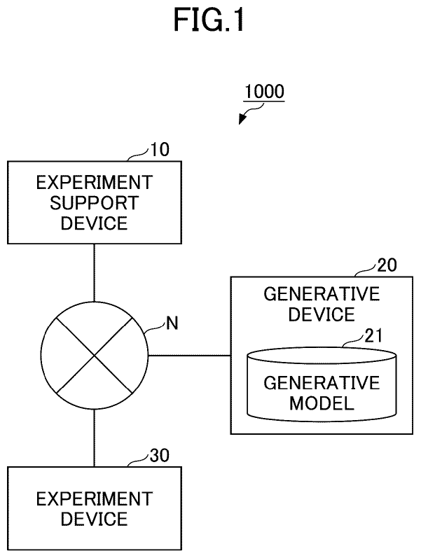

An overall configuration of the experiment support system according to the present embodiment will be described with reference to FIG. 1. FIG. 1 is a block diagram illustrating an example of the overall configuration of the experiment support system.

As illustrated in FIG. 1, an experiment support system 1000 includes an experiment support device 10, a generative device 20, and an experiment device 30. The experiment support device 10, the generative device 20, and the experiment device 30 may be connected to each other via a communication network N, such as a local area network (LAN) or the Internet, so as to be able to perform data communication.

The experiment support device 10 is an example of an information processing device, such as a personal computer, a workstation, or a server configured to generate a program to be executed by the experiment device 30. The experiment support device 10 may generate the program based on a generative model 21 included in the generative device 20.

The experiment support device 10 receives an input of an experimental condition designated by a user (for example, an experimenter) of the experiment support system 1000. The experiment support device 10 generates input information to be input into the generative model 21 based on the received experimental condition and transmits the input information to the generative device 20. The experiment support device 10 receives, from the generative device 20, an output result generated by inputting the input information into the generative model 21.

In the present embodiment, the input information to be input into the generative model 21 includes instruction information for instructing that the program to be executed by the experiment device 30 is to be generated, an experimental condition designated by the user, and reference information related to the experiment device 30. Therefore, the output result from the generative model 21 includes a program that can be executed by the experiment device 30 and satisfies the experimental condition designated by the user.

The generative device 20 is an example of an information processing device, such as a personal computer, a workstation, or a server configured to perform a task of generating predetermined data. The generative device 20 may include the generative model 21. The generative model 21 is a machine learning model trained to perform a task of generating predetermined data. The generative model 21 may be a large-scale language model, for example.

The generative model 21 may be implemented by, for example, one generative model. Additionally, for example, the generative model 21 may be implemented by multiple generative models cooperating with each other. The generative model 21 may be configured by multiple generative models corresponding to tasks to be performed.

The generative device 20 receives the input information to be input into the generative model 21 from the experiment support device 10. The generative device 20 transmits, to the experiment support device 10, the output result generated by inputting the input information into the generative model 21.

The experiment device 30 is an example of a device configured to execute the program generated by the generative model 21. The experiment device 30 may be an example of an information processing device, such as a personal computer, a workstation, or a server configured to execute the program. The experiment device 30 may be a device configured to acquire a predetermined physical quantity related to a predetermined material. The experiment device 30 may be, for example, a prediction device configured to predict a predetermined physical quantity based on a learned model. The learned model may be, for example, a machine learning model based on deep learning. The learned model may be, for example, a neural network potential (NNP) configured to receive an input of an atomic structure and output energy or force corresponding to the atomic structure. The experiment device 30 may be, for example, a simulation device configured to calculate a predetermined physical quantity by molecular simulation, such as molecular dynamics calculation. The experiment device 30 may be a measurement device configured to measure a predetermined physical quantity by using a sample including a predetermined material.

The experiment device 30 may be a device configured to acquire one physical quantity. The experiment device 30 may be a device configured to acquire multiple physical quantities simultaneously or sequentially. The experiment device 30 may include multiple devices corresponding to the physical quantities to be acquired. The experiment device 30 may be a system configured to acquire a predetermined physical quantity by multiple devices cooperating with each other.

Here, the overall configuration of the experiment support system 1000 illustrated in FIG. 1 is an example, and various system configuration examples may be used according to the use and purpose. The experiment support system 1000 may be configured by one or more devices. The device included in the experiment support system 1000 may be a system configured by multiple devices. Each function included in the experiment support system 1000 may be realized by any device constituting the system. Each component included in the experiment support system 1000 may be included in any device constituting the system.

The generative model 21 may be included inside one generative device 20. The generative model 21 may be included inside the experiment support device 10 or the experiment device 30. The generative model 21 may be distributed and held in external devices or system including multiple devices. In this case, the experiment support system 1000 does not need to include the generative device 20.

The experiment support system 1000 may include multiple of one or more of the experiment support device 10, the generative device 20, and the experiment device 30. The experiment support device 10, the generative device 20, and the experiment device 30 may be implemented by multiple computers or may be implemented as a service of cloud computing. Two or more of the experiment support device 10, the generative device 20, and the experiment device 30 may be implemented by a stand-alone computer. For example, the experiment support device 10 and the experiment device 30 may be implemented by one or more devices. The division of the devices such as the experiment support device 10, the generative device 20, and the experiment device 30 illustrated in FIG. 1 is an example.

### <Functional Configuration of Experiment Support Device>

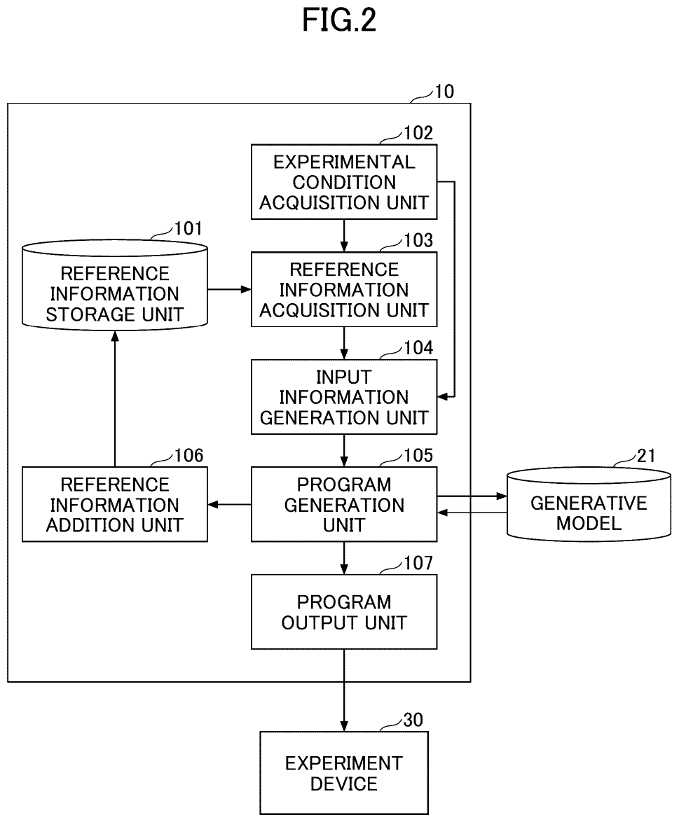

A functional configuration of the experiment support device 10 will be described with reference to FIG. 2. FIG. 2 is a block diagram illustrating an example of a functional configuration of the experiment support device.

As illustrated in FIG. 2, the experiment support device 10 includes a reference information storage unit 101, an experimental condition acquisition unit 102, a reference information acquisition unit 103, an input information generation unit 104, a program generation unit 105, a reference information addition unit 106, and a program output unit 107. The experiment support device 10 functions as the reference information storage unit 101, the experimental condition acquisition unit 102, the reference information acquisition unit 103, the input information generation unit 104, the program generation unit 105, the reference information addition unit 106, and the program output unit 107 by executing an experiment support program installed in advance.

The reference information storage unit 101 stores, in advance, multiple pieces of reference information related to the experiment device 30. The reference information may be information related to a function of the experiment device 30. The information related to the function may be, for example, information related to an interface for calling the function of the experiment device 30. The information related to the interface may include, for example, definition information on the interface and a sample program using the interface.

The interface may be, for example, a function, an application programming interface (API), or the like for calling each function included in the experiment device 30. The interfaces may be hierarchized into a library, a class, or the like. The definition information may include, for example, information related to a name, a description, and an input of the interface (for example, a name, a data type, and a description of each variable and the like), and information related to an output (for example, a name, a data type, and a description of each variable and the like).

The sample program may be a program in which an interface is used in a predetermined programming language. Each interface may be used by one or more sample programs. The sample program may use multiple interfaces. The sample program may include a comment describing the content of the process executed by the program.

The definition information on the interface and the sample program may be described by a user or may be generated based on a generative model. The generative model may be the generative model 21 included in the generative device 20 or may be another generative model different from the generative model 21. The other generative model may be included in the experiment support device 10 or the generative device 20, or may be included in an external device or system.

The input information to be input into the generative model when generating the definition information based on the generative model may include instruction information for instructing that the definition information on the interface is to be generated and a program using the interface. The definition information generated based on the generative model may be modified by the user.

The experimental condition acquisition unit 102 acquires an experimental condition designated by the user. The experimental condition may be a character string described in a natural language sentence. The experimental condition may include material information indicating a material used for the experiment and objective information indicating an object of the experiment. The experimental condition may include multiple of either or both of the material information and the objective information. The number of the material information or the objective information may vary depending on the experiment to be performed. The experimental condition may include a condition for simulation.

The material information may include, for example, a compound name, a structural formula, data indicating a structure of a substance, data indicating a three-dimensional structure of a substance, and the like. The target information may include, for example, a type of a physical quantity, a structure of a substance, a state of a substance, a chemical reaction, and the like. The structure of the substance may include an atomic structure. The atomic structure may include, for example, information related to a type and a position of an atom.

The data indicating the structure of the substance may be a character string described in a predetermined linear notation. The linear notation may be, for example, the simplified molecular input line entry system (SMILES), the extended connectivity circular fingerprints (ECFP), or the like. The data indicating the structure of the substance may include information indicating an electronic file in which the structure of the substance is described. The information indicating the electronic file may include, for example, a file name, a file path, a uniform resource identifier (URI), and the like.

The data indicating the three-dimensional structure of the substance may be an electronic file in which the three-dimensional structure of the substance is recorded in a predetermined file format. The file format may be, for example, a MOL format, a structure data file (SDF) format, or the like. The data indicating the three-dimensional structure of the substance may include information indicating an electronic file in which the three-dimensional structure of the substance is recorded.

The reference information acquisition unit 103 acquires the reference information from the reference information storage unit 101. The reference information acquisition unit 103 may acquire all the reference information stored in the reference information storage unit 101. The reference information acquisition unit 103 may acquire a part of the reference information stored in the reference information storage unit 101.

When acquiring a part of the reference information, the reference information acquisition unit 103 may extract the reference information related to the experimental condition acquired by the experimental condition acquisition unit 102. The reference information acquisition unit 103 may extract the reference information based on the degree of association between the experimental condition and the reference information, for example. The reference information acquisition unit 103 may extract a predetermined number of the multiple pieces of reference information in order from the higher degree of association, for example. The degree of association may be, for example, a degree of text similarity. Specifically, the reference information acquisition unit 103 may convert each of the experimental condition and the reference information into an embedding vector, and extract a predetermined number of the multiple pieces of reference information in order from the shorter distance between the embedding vectors. The reference information acquisition unit 103 may use tf-idf as the feature of a document. The reference information acquisition unit 103 may extract the reference information by using a search engine such as Elasticsearch, for example.

When the number of the multiple pieces of reference information stored in the reference information storage unit 101 is large, the amount of data of the input information to be input into the generative model 21 becomes enormous. If the amount of data that can be received by the generative model 21 as the input information is limited, all the pieces of reference information cannot be included in the input information. Additionally, when the input information includes a large amount of information related to an interface that is not related to the experimental condition, the processing time for the generative model 21 to generate a program may be increased. By extracting the reference information related to the experimental condition from all the reference information and including the extracted reference information in the input information, the program can be generated more reliably and in a shorter time.

The input information generation unit 104 generates the input information to be input into the generative model 21 based on the experimental condition acquired by the experimental condition acquisition unit 102. The input information generation unit 104 may include the experimental condition acquired by the experimental condition acquisition unit 102 and the reference information acquired by the reference information acquisition unit 103 in the input information to be input into the generative model 21. The input information generation unit 104 may generate the input information in which the reference information and the experimental condition are combined in this order, for example.

The input information may include text data, image data, or sound data. The text data may be, for example, a natural language sentence called a prompt. The image data may be, for example, a still image or a moving image. The image data may include, for example, an image obtained by capturing the user. The sound data may include, for example, a voice uttered by the user. The input information may include a result of recognizing image data or sound data.

The input information generation unit 104 may include predetermined instruction information in the input information to be input into the generative model 21. The predetermined instruction information may include information instructing that the reference information is to be referred to. The predetermined instruction information may include information instructing that the experimental condition is to be referred to. The predetermined instruction information may be, for example, instruction information for instructing that a program using an interface included in the reference information is to be generated. The input information generation unit 104 may include, for example, the instruction information in the input information such that the instruction information is positioned between the reference information and the experimental condition in the input information.

The input information generation unit 104 may generate multiple pieces of input information. The input information generation unit 104 may generate, for example, first input information including the reference information and second input information including the experimental condition. When the instruction information is included in the input information, the input information generation unit 104 may add the instruction information to the end of the first input information (that is, after the reference information), may add the instruction information to the head of the second input information (that is, before the experimental condition), or may generate third input information including the instruction information between the first input information and the second input information.

The program generation unit 105 generates the program to be executed by the experiment device 30 based on the input information generated by the input information generation unit 104. The program generation unit 105 may generate the program based on the generative model 21 included in the generative device 20. Specifically, the program generation unit 105 may transmit, to the generative device 20, the input information to be input into the generative model 21. The program generation unit 105 may receive, from the generative device 20, an output result generated by the generative device 20 inputting the input information into the generative model 21. The program generation unit 105 may acquire the program from the output result received from the generative device 20.

The reference information addition unit 106 stores the reference information including the program acquired by the program generation unit 105 in the reference information storage unit 101. Specifically, the reference information addition unit 106 may extract the interface of the experiment device 30 from the programs and add the program including the extracted interface, as a sample program, to the reference information including the definition information on the extracted interface. The reference information addition unit 106 may generate new reference information including the definition information on the extracted interface and the program, and store the new reference information in the reference information storage unit 101.

As the number of the sample programs included in the input information to be input into the generative model 21 increases, it can be expected that the accuracy of the program generated by the generative model 21 is improved. By adding the program generated by the generative model 21 as a sample program, the accuracy of the program generated by the experiment support device 10 is improved.

The program output unit 107 outputs the program acquired by the program generation unit 105. The program output unit 107 may display the program on a display or the like of the experiment support device 10. The program displayed on the display or the like may be input to the experiment device 30 by the user. The program output unit 107 may transmit the program to the experiment device 30.

### Specific Example of Experimental Condition

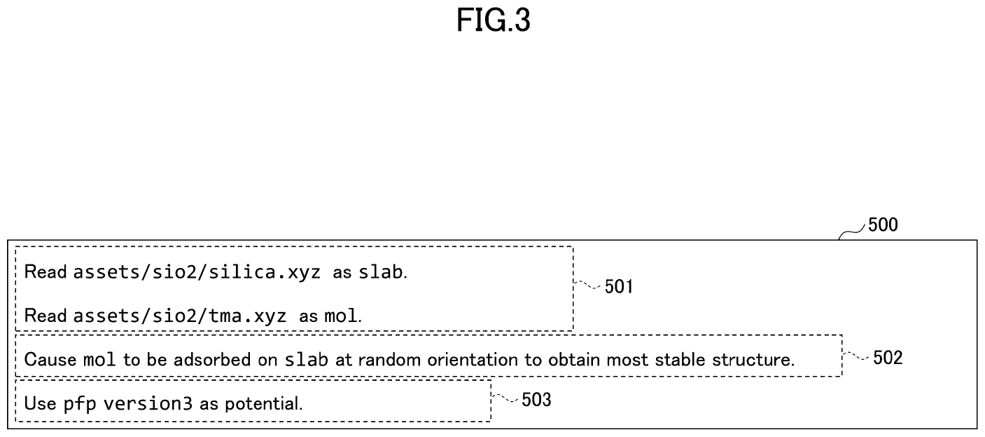

The experimental condition designated by the user will be described specifically with reference to FIG. 3. FIG. 3 is a diagram illustrating an example of the experimental condition.

As illustrated in FIG. 3, an experimental condition 500 may include material information 501, objective information 502, and a constraint condition 503. The material information 501 is an example of the file path of the electronic file in which the three-dimensional structure of the substance is recorded. The material information 501 includes material information related to multiple materials. Here, although FIG. 3 illustrates the material information indicating the electronic file in which the three-dimensional structure of the substance is recorded, the material information may directly describe the information indicating the three-dimensional structure of the substance.

The objective information 502 is an example of the structure of the substance to be obtained by the experiment. The constraint condition 503 is information indicating a constraint that is a premise in the experiment. The constraint condition 503 is an example of information for designating a potential that is a premise of calculation.

### Specific Example of Input Information for Generating Program

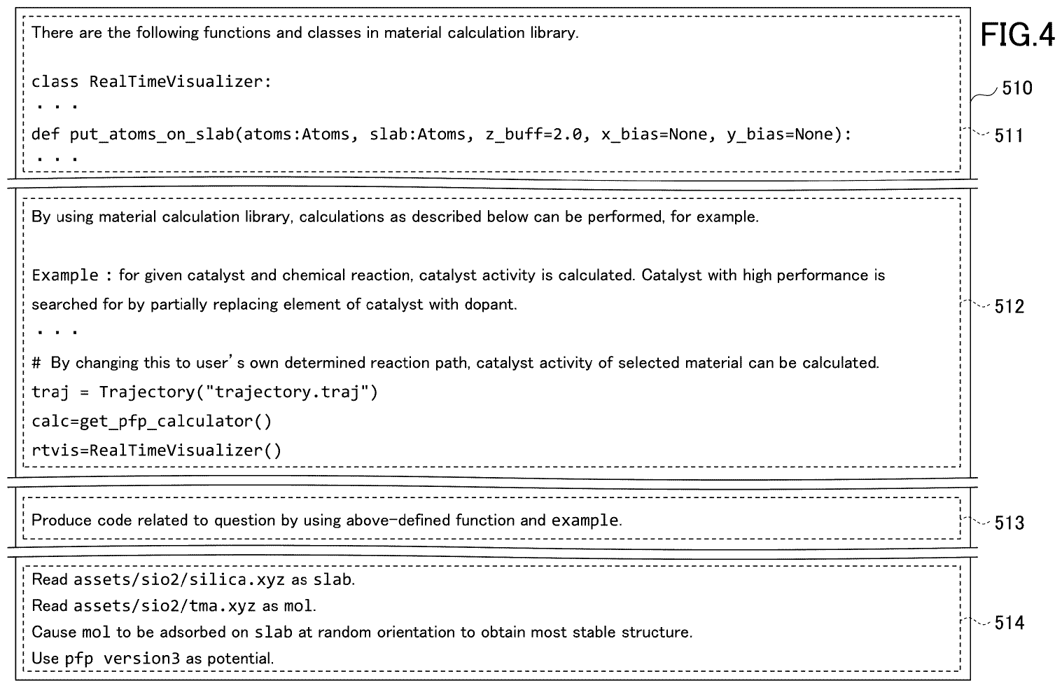

The input information for generating a program based on the generative model 21 will be described specifically with reference to FIG. 4. FIG. 4 is a diagram illustrating an example of the input information for generating a program.

As illustrated in FIG. 4, input information 510 may include definition information 511, a sample program 512, instruction information 513, and an experimental condition 514. The definition information 511 is an example of a character string describing a definition of a class and a function included in a library provided by the experiment device 30. The sample program 512 is an example of a program in which the class or the function included in the definition information 511 is used. The definition information 511 and the sample program 512 are examples of the reference information.

The instruction information 513 is an example of a character string instructing that a program is to be generated by using the definition information 511. The experimental condition 514 is an example of the experimental condition designated by the user. FIG. 4 illustrates the experimental condition 500 illustrated in FIG. 3.

The instruction information 513 may be predetermined and stored in a storage unit included in the experiment support device 10. The instruction information 513 may be determined for each type of the experiment device 30. The instruction information 513 may be designated by the user. The designation of the instruction information 513 by the user may be performed at any timing. For example, the user may designate the instruction information 513 before using the experiment support device 10, or may designate the instruction information 513 each time the user inputs the experimental condition.

The instruction information 513 may include, for example, a content prompting to use a function, a content prompting to use a sample program, and additional information prompting to present a code related to a question. The additional information may be a predetermined fixed phrase or may be determined based on a user's instruction. Here, the question may be the objective information 502 included in the experimental condition 514, or may include a question and the like related to interpretation of the experiment result or the operation principle of the experiment device 30.

### Specific Example of Output Result Including Program

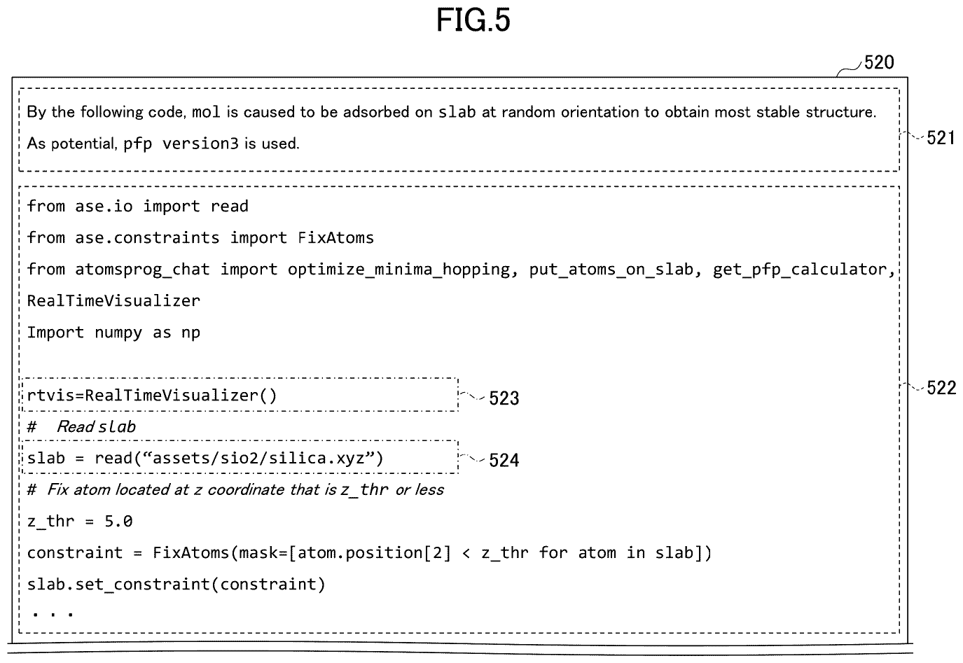

The output result including the program generated by the generative model 21 will be described specifically with reference to FIG. 5. FIG. 5 is a diagram illustrating an example of the output result including the program.

As illustrated in FIG. 5, an output result 520 may include response information 521 and a program 522. The response information 521 is an example of a character string used by the generative model 21 in responding to the instruction indicated in the input information 510. The response information 521 is not required to be included in the output result 520.

The program 522 is an example of the program generated by the generative model 21 in accordance with the input information 510. The program 522 includes a code 523 using the class indicated in the definition information 511 of the input information 510 and a code 524 using the material information indicated in the experimental condition 514 of the input information 510.

### Specific Example of Input Information for Generating Definition Information

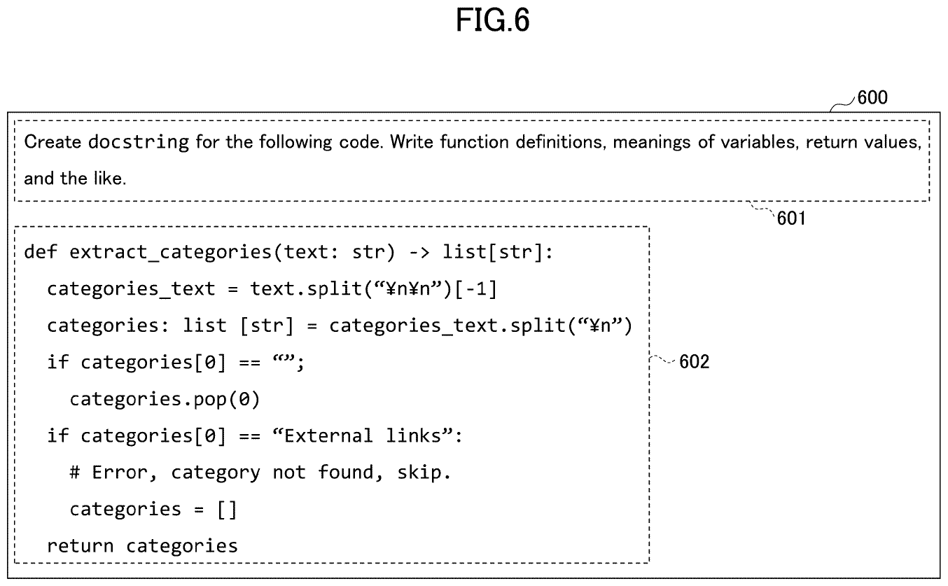

The input information for generating the definition information based on the generative model (for example, the generative model 21) will be described specifically with reference to FIG. 6. Here, the definition information may be generated using a generative model other than the generative model 21. FIG. 6 is a diagram illustrating an example of the input information for generating the definition information.

As illustrated in FIG. 6, input information 600 may include instruction information 601 and a program 602. The instruction information 601 is an example of a character string instructing that definition information is to be generated based on the program 602. The program 602 is an example of a program for which the definition information is to be generated. The program 602 may be a class or a function provided by the experiment device 30, or may be a class or a function described by the user.

### Specific Example of Output Result Including Definition Information

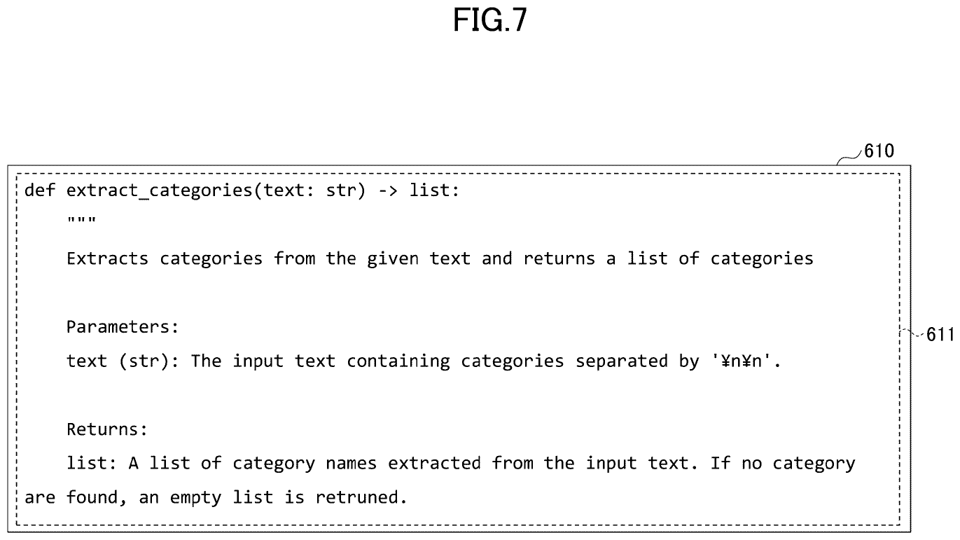

The output result including the definition information generated by the generative model 21 will be described specifically with reference to FIG. 7. FIG. 7 is a diagram illustrating an example of the output result including the definition information.

As illustrated in FIG. 7, an output result 610 may include definition information 611. The definition information 611 is an example of the definition information generated by the generative model 21 in accordance with the input information 600. The definition information 611 describes an input, an output, and the like defined by the program 602 of the input information 600. The definition information 611 may be added to the reference information together with the program 602 of the input information 600. The definition information 611 may be added to the reference information after being modified by the user.

### <Flow of Experiment Support Method>

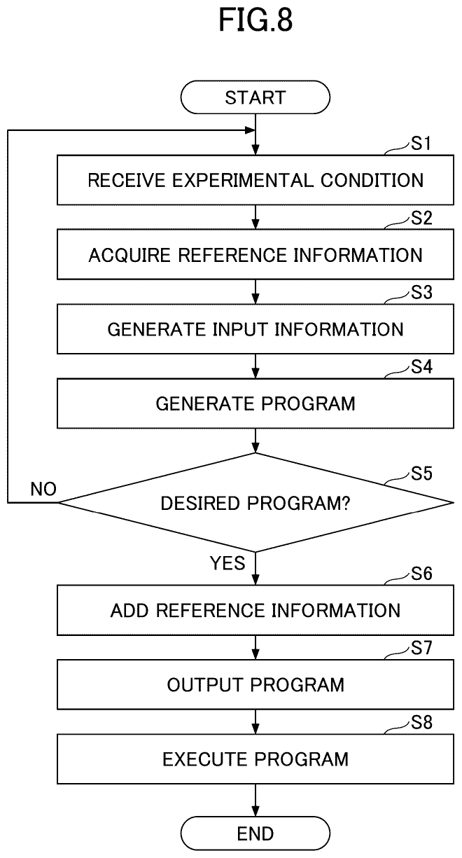

A experiment support method performed by the experiment support system 1000 will be described with reference to FIG. 8. FIG. 8 is a flowchart illustrating an example of the experiment support method.

In step S1, the user of the experiment support system 1000 performs an operation of inputting the experimental condition. The operation of inputting the experimental condition may be, for example, an operation of inputting a natural language sentence describing the experimental condition on a screen displayed on a display device of the experiment support device 10, or an operation of causing a microphone of the experiment support device 10 to collect a voice-based utterance conveying the experimental condition. The screen may be implemented by an interactive user interface, for example. The interactive user interface may be, for example, a screen having a chat type display area.

The experimental condition acquisition unit 102 of the experiment support device 10 receives the operation of inputting the experimental condition. Next, the experimental condition acquisition unit 102 acquires the experimental condition designated by the user based on the received operation. Then, the experimental condition acquisition unit 102 transmits information indicating the received experimental condition to the reference information acquisition unit 103 and the input information generation unit 104.

In step S2, the reference information acquisition unit 103 of the experiment support device 10 receives information indicating the experimental condition from the experimental condition acquisition unit 102. Next, the reference information acquisition unit 103 reads the reference information from the reference information storage unit 101. At this time, the reference information acquisition unit 103 may extract the reference information related to the experimental condition from the multiple pieces of reference information stored in the reference information storage unit 101. Then, the reference information acquisition unit 103 transmits the acquired reference information to the input information generation unit 104.

In step S3, the input information generation unit 104 of the experiment support device 10 receives information indicating the experimental condition from the experimental condition acquisition unit 102. Additionally, the input information generation unit 104 receives the reference information from the reference information acquisition unit 103. Next, the input information generation unit 104 generates the input information to be input into the generative model 21 based on the experimental condition and the reference information. For example, the input information generation unit 104 may generate the input information in which the reference information, the predetermined instruction information, and the experimental information are combined in this order. Then, the input information generation unit 104 transmits the generated input information to the program generation unit 105.

In step S4, the program generation unit 105 of the experiment support device 10 receives the input information to be input into the generative model 21 from the input information generation unit 104. Next, the program generation unit 105 transmits the received input information to the generative device 20.

The generative device 20 receives the input information from the experiment support device 10. Next, the generative device 20 inputs the received input information into the generative model 21. The generative model 21 performs a task of generating the program in accordance with the input information that is input, and outputs an output result including the program generated by performing the task. Then, the generative device 20 transmits the output result of the generative model 21 to the experiment support device 10.

In the experiment support device 10, the program generation unit 105 receives the output result of the generative model 21 from the generative device 20. Next, the program generation unit 105 acquires the program from the received output result. Subsequently, the program generation unit 105 presents the received output result to the user. The program generation unit 105 may display the received output result on the screen displayed on the display device of the experiment support device 10, for example.

In step S5, the user determines whether the program included in the output result presented in step S4 is a desired program. The desired program may be a program that satisfies the experimental condition designated by the user in step S1. That is, the user determines whether the program presented in step S4 is a program that performs the experiment desired to be performed. The user may determine whether the program is the desired program based on user's knowledge.

The experiment support device 10 may determine whether the presented program is the desired program. For example, the experiment support device 10 may debug the presented program and determine whether the program has a problem. The program may be debugged using a debugger installed in the experiment support device 10 in advance. The debugger may include, for example, a grammar checker or a test framework. The determination of whether the presented program is the desired program may be performed by combining the determination by the user and the determination by the experiment support device 10.

When it is determined that the presented program is not the desired program (NO), the user may perform an operation of instructing that the program is to be corrected. The operation of instructing that the program is to be corrected may be an operation of inputting instruction information for instructing that the program is to be corrected. The instruction information for instructing that the program is to be corrected may include, for example, an error message included in the output result, information for identifying an erroneous portion in the program, and the like. The user may correct the program determined not to be the desired program.

When it is determined that the presented program is the desired program (YES), the user may perform an operation of outputting the program. The program generation unit 105 of the experiment support device 10 receives the operation of outputting the program by the user. Next, the program generation unit 105 transmits the program acquired in step S4 to the reference information addition unit 106 and the program output unit 107.

When receiving the operation of outputting the program, the program generation unit 105 may store the input information that has been input into the generative model 21 in step S4 in the storage unit included in the experiment support device 10. The program generation unit 105 may store the output information output from the generative model 21 in the storage unit together with the input information. The input information and the output information stored in the storage unit may be used when the user inputs the experimental condition in step S1. As one example, the experimental condition acquisition unit 102 may present the input information stored in the storage unit to the user and receive the input information selected by the user. As another example, when the user instructs to correct the program, the input information generation unit 104 may acquire the program of the portion designated by the user from the output information stored in the storage unit and include the acquired program in the instruction information for instructing that the program is to be corrected.

In step S6, the reference information addition unit 106 of the experiment support device 10 receives the program from the program generation unit 105. Next, the reference information addition unit 106 extracts the interface of the experiment device 30 from the received program. Subsequently, the reference information addition unit 106 adds the received program, as a sample program, to the reference information including the definition information on the extracted interface.

In step S7, the program output unit 107 of the experiment support device 10 acquires the program from the result that is output from the generative model 21 and that is received in step S4. Next, the program output unit 107 outputs the acquired program. As one example, the program output unit 107 may store the acquired program in the storage device of the experiment support device 10 and then display the program on the display of the experiment support device 10. As another example, the program output unit 107 may transmit the acquired program to the experiment device 30.

In step S8, the experiment device 30 executes the program output in step S7. When the program is an interpreter type program, the experiment device 30 inputs a source code of the program into an interpreter installed in advance. The interpreter executes the program while sequentially interpreting the source code.

When the program is a compile type program, the experiment device 30 inputs a source code of the program into a compiler installed in advance. The compiler generates a binary code by compiling the source code. The experiment device 30 executes the binary code. Here, the compilation may be performed by a device other than the experiment device 30. For example, the experiment support device 10 may compile the source code of the program and transmit the binary code to the experiment device 30.

When the experiment device 30 is a prediction device, the experiment device 30 predicts a predetermined physical quantity related to a predetermined material by executing the program. When the experiment device 30 is a simulation device, the experiment device 30 performs molecular simulation according to the program and calculates a predetermined physical quantity related to a predetermined material. When the experiment device 30 is a measurement device, the experiment device 30 measures a predetermined physical quantity using a sample including a predetermined material.

When the experiment device 30 requires the user's operation, the program output unit 107 of the experiment support device 10 may display the operation to be performed by the user on the experiment device 30 on the display device or the like of the experiment support device 10. The case where the user operation is required includes, for example, a case where the experiment device 30 is a measurement device and a sample or the like needs to be set at a predetermined position.

### Conclusion

As is clear from the above description, the experiment support device 10 according to the embodiment of the present disclosure acquires the experimental condition designated by the user, generates the input information for generating the program to be executed by the experiment device 30, and acquires the program generated by inputting the input information into the generative model 21. The input information includes the reference information related to the experiment device 30, the instruction information, and the experimental condition. The reference information includes the definition information related to the interface for executing the function of the experiment device 30 and the sample program using the interface. The instruction information includes the information instructing that the program is to be generated.

The instruction information may be located between the reference information and the experimental condition in the input information. The instruction information may include the information instructing that the reference information is to be referred to. The instruction information may include the information instructing that the experimental condition is to be referred to. The instruction information may include a fixed phrase related to the generation of the program.

The definition information may be generated by inputting second input information including the sample program into the generative model 21.

The experiment support device 10 may store multiple pieces of reference information generated in advance, acquire the reference information from the multiple pieces of reference information based on the experimental condition, and generate the input information by using the acquired reference information. The experiment support device 10 may store the generated program as the reference information.

The experiment support device 10 may generate second input information related to the correction of the program based on the instruction from the user after the program is generated, and may acquire a second program generated by inputting the second input information into the generative model 21.

The experimental condition may include information indicating a substance. The information indicating the substance may include information indicating a three-dimensional structure of the substance. The information indicating the substance may include information indicating a file in which the three-dimensional structure is recorded.

The experiment device 30 may be a prediction device configured to predict a physical quantity of a substance based on a learned model. The experiment device 30 may be a simulation device configured to calculate a physical quantity of a substance by simulation. The experiment device 30 may be a measurement device configured to measure a physical quantity of a substance by using a sample including the substance.

With this, according to the embodiment of the present disclosure, a device that can generate the program to be executed by the experiment device can be provided. In one aspect, according to the embodiment, an experiment for acquiring a predetermined physical quantity related to a predetermined material can be efficiently performed. In another aspect, according to the embodiment, material development can be efficiently advanced, and a new material can be provided in a short lead time.

### [Hardware Configuration of Information Processing Device]

Some or all of the devices (the experiment support device 10, the generative device 20, and the experiment device 30) in the above-described embodiments may be configured by hardware or may be configured by information processing of software (program) executed by a central processing unit (CPU), a graphics processing unit (GPU), or the like. In the case where the embodiment is configured by the information processing of software, software for realizing at least some of the functions of the devices in the above-described embodiments may be stored in a non-transitory storage medium (a non-transitory computer-readable medium), such as a compact disc-read only memory (CD-ROM) or a universal serial bus (USB) memory, and a computer may read the software to perform the information processing of the software. Additionally, the software may be downloaded via a communication network. Furthermore, all or some of the processes of software may be implemented in a circuit, such as an application specific integrated circuit (ASIC) or a field programmable gate array (FPGA), and the information processing by the software may be executed by hardware.

The storage medium storing the software may be a removable medium, such as an optical disk, or a fixed storage medium, such as a hard disk or a memory. Additionally, the storage medium may be provided inside the computer (a main storage device, an auxiliary storage device, or the like) or may be provided outside the computer.

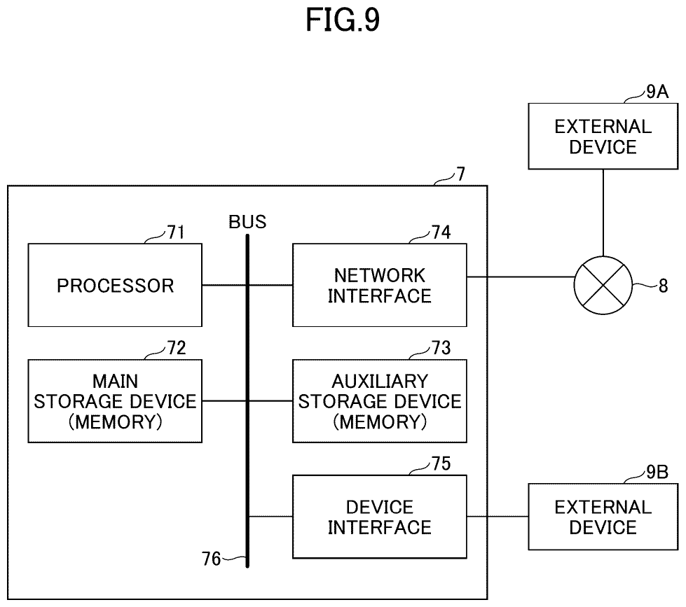

FIG. 9 is a block diagram illustrating an example of a hardware configuration of the devices (the experiment support device 10, the generative device 20, and the experiment device 30) in the above-described embodiments. Each of the devices may be implemented as a computer 7 including a processor 71, a main storage device 72 (memory), an auxiliary storage device 73 (memory), a network interface 74, and a device interface 75, which are connected via a bus 76, for example.

The computer 7 of FIG. 9 includes one of each component, but may include multiple units of the same components. Additionally, although FIG. 9 illustrates one computer 7, the software may be installed in multiple computers, and the multiple computers may execute the same or different partial processes of the software. In this case, the computers may be in a distributed computing form in which the computers communicate with each other via the network interface 74 or the like to perform the processes. That is, the devices (the experiment support device 10, the generative device 20, and the experiment device 30) in the above-described embodiments may be configured as a system that realizes a function by one or more computers executing instructions stored in one or more storage devices. Additionally, the devices may be configured such that information transmitted from a terminal may be processed by one or more computers provided on a cloud, and the processing result may be transmitted to the terminal.

The various operations of the devices (the experiment support device 10, the generative device 20, and the experiment device 30) in the above-described embodiments may be performed by parallel processing using one or more processors or using multiple computers connected via a network. Additionally, various operations may be distributed to multiple operation cores in the processor and performed by parallel processing. Additionally, some or all of the processes, means, and the like of the present disclosure may be implemented by at least one of a processor or a storage device provided on a cloud that can communicate with the computer 7 via a network. As described above, each of the devices in the above-described embodiments may be in a form of parallel computing by one or more computers.

The processor 71 may be an electronic circuit (a processing circuit, processing circuitry, a CPU, a GPU, an FPGA, an ASIC, or the like) that performs at least one of control or operations of a computer. Additionally, the processor 71 may be any of a general-purpose processor, a dedicated processing circuit designed to execute a specific operation, or a semiconductor device including both the general-purpose processor and the dedicated processing circuit. Additionally, the processor 71 may include an optical circuit or may include an arithmetic function based on quantum computing.

The processor 71 may perform arithmetic processing based on data or software input from each device or the like of the internal configuration of the computer 7, and may output an arithmetic result or a control signal to each device or the like. The processor 71 may control each component constituting the computer 7 by executing an operating system (OS), an application, or the like of the computer 7.

The devices (the experiment support device 10, the generative device 20, and the experiment device 30) in the above-described embodiments may be implemented by one or more processors 71. Here, the processor 71 may refer to one or more electronic circuits disposed on one chip, or may refer to one or more electronic circuits disposed on two or more chips or two or more devices. When multiple electronic circuits are used, the electronic circuits may communicate with each other by wire or wirelessly.

The main storage device 72 may store instructions executed by the processor 71, various data, and the like, and information stored in the main storage device 72 may be read by the processor 71. The auxiliary storage device 73 is a storage device other than the main storage device 72. Here, these storage devices indicate any electronic components capable of storing electronic information, and may be semiconductor memories. The semiconductor memory may be either a volatile memory or a nonvolatile memory. The storage device for storing various data and the like in the device in the above-described embodiments (the experiment support device 10, the generative device 20, and the experiment device 30) may be realized by the main storage device 72 or the auxiliary storage device 73, or may be realized by a built-in memory built in the processor 71. For example, the storage devices in the above-described embodiments may be realized by the main storage device 72 or the auxiliary storage device 73.

When the device in the above-described embodiments (the experiment support device 10, the generative device 20, and the experiment device 30) includes at least one storage device (memory) and at least one processor connected (coupled) to the at least one storage device, the at least one processor may be connected to one storage device.

Additionally, at least one storage device may be connected to one processor. Additionally, a configuration in which at least one processor among the multiple processors is connected to at least one storage device among the multiple storage devices may be included. Additionally, this configuration may be realized by storage devices and the processors included in multiple computers. Furthermore, a configuration in which the storage device is integrated with the processor (for example, an L1 cache or a cache memory including an L2 cache) may be included.

The network interface 74 is an interface for connecting to a communication network 8 by wire or wirelessly. As the network interface 74, an appropriate interface, such as one conforming to an existing communication standard, may be used. The network interface 74 may exchange information with an external device 9A connected via the communication network 8. Here, the communication network 8 may be any one of a wide area network (WAN), a local area network (LAN), a personal area network (PAN), and the like, or a combination thereof, as long as information is exchanged between the computer 7 and the external device 9A. Examples of the WAN include the Internet and the like, and examples of the LAN include IEEE802.11, Ethernet (registered trademark), and the like. Examples of the PAN include Bluetooth (registered trademark), Near Field Communication (NFC), and the like. The device interface 75 is an interface, such as a USB, that is directly connected to an external device 9B.

The external device 9A is a device connected to the computer 7 via a network. The external device 9B is a device directly connected to the computer 7.

The external device 9A or the external device 9B may be, for example, an input device. The input device is, for example, a device, such as a camera, a microphone, a motion capture device, various sensors, a keyboard, a mouse, a touch panel, or the like, and gives acquired information to the computer 7. Alternatively, the device may be a device including an input unit, a memory, and a processor, such as a personal computer, a tablet terminal, or a smartphone.

Additionally, the external device 9A or the external device 9B may be, for example, an output device. The output device may be, for example, a display device, such as a liquid crystal display (LCD) or an organic electro luminescence (EL) panel, or may be a speaker that outputs sound or the like. Alternatively, the device may be a device including an output unit, a memory, and a processor, such as a personal computer, a tablet terminal, or a smartphone.

Additionally, the external device 9A or the external device 9B may be a storage device (a memory). For example, the external device 9A may be a network storage or the like, and the external device 9B may be a storage, such as a hard disk drive (HDD).

Additionally, the external device 9A or the external device 9B may be a device having a function of a part of the components of the device in the above-described embodiments (the experiment support device 10, the generative device 20, and the experiment device 30). That is, the computer 7 may transmit a part or all of the processing result to the external device 9A or the external device 9B, or may receive a part or all of the processing result from the external device 9A or the external device 9B.

In the present specification (including the claims), if the expression “at least one of a, b, and c” or “at least one of a, b, or c” is used (including similar expressions), any one of a, b, c, a-b, a-c, b-c, or a-b-c is included. Multiple instances may also be included in any of the elements, such as a-a, a-b-b, and a-a-b-b-c-c. Further, the addition of another element other than the listed elements (i.e., a, b, and c), such as adding d as a-b-c-d, is included.

In the present specification (including the claims), if the expression such as “in response to data being input”, “using data”, “based on data”, “according to data”, or “in accordance with data” (including similar expressions) is used, unless otherwise noted, a case in which the data itself is used and a case in which data obtained by processing the data (e.g., data obtained by adding noise, normalized data, a feature amount extracted from the data, and intermediate representation of the data) is used are included. If it is described that any result can be obtained “in response to data being input”, “using data”, “based on data”, “according to data”, or “in accordance with data” (including similar expressions), unless otherwise noted, a case in which the result is obtained based on only the data is included, and a case in which the result is obtained affected by another data other than the data, factors, conditions, and/or states may be included. If it is described that “data is output” (including similar expressions), unless otherwise noted, a case in which the data itself is used as an output is included, and a case in which data obtained by processing the data in some way (e.g., data obtained by adding noise, normalized data, a feature amount extracted from the data, and intermediate representation of the data) is used as an output is included.

In the present specification (including the claims), if the terms “connected” and “coupled” are used, the terms are intended as non-limiting terms that include any of direct, indirect, electrically, communicatively, operatively, and physically connected/coupled. Such terms should be interpreted according to a context in which the terms are used, but a connected/coupled form that is not intentionally or naturally excluded should be interpreted as being included in the terms without being limited.

In the present specification (including the claims), if the expression “A configured to B” is used, a case in which a physical structure of the element A has a configuration that can perform the operation B, and a permanent or temporary setting/configuration of the element A is configured/set to actually perform the operation B may be included. For example, if the element A is a general purpose processor, the processor may have a hardware configuration that can perform the operation B and be configured to actually perform the operation B by setting a permanent or temporary program (i.e., an instruction). If the element A is a dedicated processor, a dedicated arithmetic circuit, or the like, a circuit structure of the processor may be implemented so as to actually perform the operation B irrespective of whether the control instruction and the data are actually attached.

In the present specification (including the claims), if a term indicating inclusion or possession (e.g., “comprising”, “including”, or “having”) is used, the term is intended as an open-ended term, including inclusion or possession of an object other than a target object indicated by the object of the term. If the object of the term indicating inclusion or possession is an expression that does not specify a quantity or that suggests a singular number (i.e., an expression using “a” or “an” as an article), the expression should be interpreted as being not limited to a specified number.

In the present specification (including the claims), even if an expression such as “one or more” or “at least one” is used in a certain description, and an expression that does not specify a quantity or that suggests a singular number (i.e., an expression using “a” or “an” as an article) is used in another description, it is not intended that the latter expression indicates “one”. Generally, an expression that does not specify a quantity or that suggests a singular number (i.e., an expression using “a” or “an” as an article) should be interpreted as being not necessarily limited to a particular number.

In the present specification, if it is described that a particular advantage/result is obtained in a particular configuration included in an embodiment, unless there is a particular reason, it should be understood that that the advantage/result may be obtained in another embodiment or other embodiments including the configuration. It should be understood, however, that the presence or absence of the advantage/result generally depends on various factors, conditions, and/or states, and that the advantage/result is not necessarily obtained by the configuration. The advantage/result is merely an advantage/result that is obtained by the configuration described in the embodiment when various factors, conditions, and/or states are satisfied, and is not necessarily obtained in the invention according to the claim that defines the configuration or a similar configuration.

In the present specification (including the claims), if multiple hardware performs predetermined processes, each of the hardware may cooperate to perform the predetermined processes, or some of the hardware may perform all of the predetermined processes. Additionally, some of the hardware may perform some of the predetermined processes while other hardware may perform the remainder of the predetermined processes. In the present specification (including the claims), if an expression such as “one or more hardware perform a first process and the one or more hardware perform a second process” is used, the hardware that performs the first process may be the same as or different from the hardware that performs the second process. That is, the hardware that performs the first process and the hardware that performs the second process may be included in the one or more hardware. The hardware may include an electronic circuit, a device including an electronic circuit, or the like.

In the present specification (including the claims), if multiple storage devices (memories) store data, each of the multiple storage devices (memories) may store only a portion of the data or may store an entirety of the data. Additionally, a configuration in which some of the multiple storage devices store data may be included.

In the present specification (including the claims), the terms “first,” “second,” and the like are used as a method of merely distinguishing between two or more elements and are not necessarily intended to impose technical significance on their objects, in a temporal manner, in a spatial manner, in order, in quantity, or the like. Therefore, for example, a reference to first and second elements does not necessarily indicate that only two elements can be employed there, that the first element must precede the second element, that the first element must be present in order for the second element to be present, or the like.

Although the embodiments of the present disclosure have been described in detail above, the present disclosure is not limited to the individual embodiments described above. Various additions, modifications, substitutions, partial deletions, and the like can be made without departing from the conceptual idea and spirit of the invention derived from the contents defined in the claims and the equivalents thereof. For example, in the embodiments described above, if numerical values or mathematical expressions are used for description, they are presented as an example and do not limit the scope of the present disclosure. Additionally, the order of respective operations in the embodiments is presented as an example and does not limit the scope of the present disclosure.

In the disclosed technique, aspects such as those described in the following appendix are conceivable.

### Appendix 1

An information processing device includes:
at least one memory; and
at least one processor,
wherein the at least one processor is configured to:
   acquire an experimental condition designated by a user;
   generate input information for generating a program to be executed by an experiment device; and
   acquire the program generated by inputting the input information into a generative model,
wherein the input information includes reference information related to the experiment device, instruction information, and the experimental condition,
wherein the reference information includes definition information related to an interface for executing a function of the experiment device and a sample program using the interface, and
wherein the instruction information includes information instructing that the program is to be generated.

### Appendix 2

The information processing device as described in Appendix 1, wherein the instruction information is located between the reference information and the experimental condition in the input information.

### Appendix 3

The information processing device as described in Appendix 1 or 2, wherein the instruction information includes information instructing that the reference information is to be referred to.

### Appendix 4

The information processing device as described in any one of Appendix 1 to Appendix 3, wherein the instruction information includes information instructing that the experimental condition is to be referred to.

### Appendix 5

The information processing device as described in any one of Appendix 1 to Appendix 4, wherein the instruction information includes a fixed phrase related to the generation of the program.

### Appendix 6

The information processing device as described in any one of Appendix 1 to Appendix 5, wherein the definition information is generated by inputting second input information including the sample program into a generative model.

### Appendix 7

The information processing device as described in any one of Appendix 1 to Appendix 6,
wherein the at least one memory is configured to store a plurality of pieces of reference information generated in advance, and
wherein the at least one processor is configured to:
   acquire the reference information from the plurality of pieces of reference information based on the experimental condition; and
generate the input information by using the acquired reference information.

### Appendix 8

The information processing device as described in Appendix 7, wherein the at least one processor is configured to store the generated program in the at least one memory as the reference information.

### Appendix 9

The information processing device as described in any one of Appendix 1 to Appendix 8, wherein the at least one processor is configured to:
generate second input information related to a modification of the program based on an instruction from the user after the program is generated; and
acquire a second program generated by inputting the second input information into the generative model.

### Appendix 10

The information processing device as described in any one of Appendix 1 to Appendix 9, wherein the experimental condition includes information indicating a substance.

### Appendix 11

The information processing device as described in Appendix 10, wherein the information indicating the substance includes information indicating a three-dimensional structure of the substance.

### Appendix 12

The information processing device as described in Appendix 11, wherein the information indicating the substance includes information indicating a file in which the three-dimensional structure is recorded.

### Appendix 13

The information processing device as described in any one of Appendix 10 to Appendix 12, wherein the experiment device is a prediction device configured to predict a physical quantity of the substance based on a learned model.

### Appendix 14

The information processing device as described in any one of Appendix 10 to Appendix 12, wherein the experiment device is a simulation device configured to calculate a physical quantity of the substance by simulation.

### Appendix 15

The information processing device as described in any one of Appendix 10 to Appendix 12, wherein the experiment device is a measurement device configured to measure a physical quantity of the substance by using a sample including the substance.

### Appendix 16

An information processing method includes:
acquiring, by at least one processor, an experimental condition designated by a user;
generating, by the at least one processor, input information for generating a program to be executed by an experiment device; and
acquiring, by the at least one processor, the program generated by inputting the input information into a generative model,
wherein the input information includes reference information related to the experiment device, instruction information, and the experimental condition,
wherein the reference information includes definition information related to an interface for executing a function of the experiment device and a sample program using the interface, and
wherein the instruction information includes information instructing that the program is to be generated.

### Appendix 17

A non-transitory computer-readable recording medium having stored therein a computer program for causing at least one processor to perform a process including:
acquiring an experimental condition designated by a user;
generating input information for generating a program to be executed by an experiment device; and
acquiring the program generated by inputting the input information into a generative model,
wherein the input information includes reference information related to the experiment device, instruction information, and the experimental condition,
wherein the reference information includes definition information related to an interface for executing a function of the experiment device and a sample program using the interface, and
wherein the instruction information includes information instructing that the program is to be generated.

What is claimed is:

1. An information processing device comprising:
at least one memory; and
at least one processor,
wherein the at least one processor is configured to:
generate input information for generating a program to be executed by an experiment device; and
acquire the program generated by inputting the input information into a generative model,
wherein the input information includes reference information related to the experiment device, and instruction information,
wherein the reference information includes definition information related to an interface for executing a function of the experiment device and a sample program using the interface, and
wherein the instruction information includes information instructing the generative model to generate the program.

2. The information processing device as claimed in claim 1,
wherein the at least one processor is configured to acquire an experimental condition designated by a user, and
wherein the input information includes the reference information, the instruction information, and the experimental condition.

3. The information processing device as claimed in claim 2, wherein the instruction information is located between the reference information and the experimental condition in the input information.

4. The information processing device as claimed in claim 1, wherein the instruction information includes information instructing that the reference information is to be referred to.

5. The information processing device as claimed in claim 2, wherein the instruction information includes information instructing that the experimental condition is to be referred to.

6. The information processing device as claimed in claim 1, wherein the instruction information includes a fixed phrase related to the generation of the program.

7. The information processing device as claimed in claim 1, wherein the definition information is generated by inputting second input information including the sample program into a generative model.

8. The information processing device as claimed in claim 2,
wherein the at least one memory is configured to store a plurality of pieces of reference information generated in advance, and
wherein the at least one processor is configured to:
acquire the reference information from the plurality of pieces of reference information based on the experimental condition; and
generate the input information by using the acquired reference information.

9. The information processing device as claimed in claim 8, wherein the at least one processor is configured to store the generated program in the at least one memory as the reference information.

10. The information processing device as claimed in claim 1, wherein the at least one processor is configured to:
generate second input information related to a modification of the program based on an instruction from a user after the program is generated; and
acquire a second program generated by inputting the second input information into the generative model.

11. The information processing device as claimed in claim 2, wherein the experimental condition includes information indicating a substance.

12. The information processing device as claimed in claim 11, wherein the information indicating the substance includes information indicating a three-dimensional structure of the substance.

13. The information processing device as claimed in claim 12, wherein the information indicating the substance includes information indicating a file in which the three-dimensional structure is recorded.

14. The information processing device as claimed in claim 11, wherein the experiment device is a prediction device configured to predict a physical quantity of the substance based on a learned model.

15. The information processing device as claimed in claim 11, wherein the experiment device is a simulation device configured to calculate a physical quantity of the substance by simulation.

16. The information processing device as claimed in claim 11, wherein the experiment device is a measurement device configured to measure a physical quantity of the substance by using a sample including the substance.

17. The information processing device as claimed in claim 1, wherein the at least one processor is configured to generate the program by inputting the input information into the generative model.

18. The information processing device as claimed in claim 1, wherein the interface is at least one of a function or an application programming interface for calling the function of the experiment device.

19. An information processing method comprising:
generating, by the at least one processor, input information for generating a program to be executed by an experiment device; and
acquiring, by the at least one processor, the program generated by inputting the input information into a generative model,
wherein the input information includes reference information related to the experiment device, and instruction information,
wherein the reference information includes definition information related to an interface for executing a function of the experiment device and a sample program using the interface, and
wherein the instruction information includes information instructing the generative model to generate the program.

20. A non-transitory computer-readable recording medium having stored therein a computer program for causing at least one processor to perform a process comprising:
generating input information for generating a program to be executed by an experiment device; and
acquiring the program generated by inputting the input information into a generative model,
wherein the input information includes reference information related to the experiment device, and instruction information,
wherein the reference information includes definition information related to an interface for executing a function of the experiment device and a sample program using the interface, and
wherein the instruction information includes information instructing the generative model to generate the program.
